(19) United States
(12) Patent Application Publication
(10) Pub. No.: US 2014/0029843 A1
(43) Pub. Date: Jan. 30, 2014

(54) METHOD FOR CLASSIFICATION OF IMAGES

(71) Applicants: Pere Obrador Espinosa, Madrid (ES); Nuria Oliver Ramirez, Madrid (ES); Ludwig Schmidt-Hackenberg, Madrid (ES)

(72) Inventors: Pere Obrador Espinosa, Madrid (ES); Nuria Oliver Ramirez, Madrid (ES); Ludwig Schmidt-Hackenberg, Madrid (ES)

(21) Appl. No.: 13/821,329

(22) PCT Filed: Aug. 29, 2011
(86) PCT No.: PCT/EP2011/064810

§ 371 Date: Oct. 16, 2013

(30) Foreign Application Priority Data
Sep. 7, 2010 (ES) P201031332

(51) Int. Cl. G06K 9/62

(52) U.S. Cl. CPC G06K 9/6267
USPC 382/165; 382/195

(57) ABSTRACT

A method for classifying an image regarding a certain subjective characteristic, the method comprising: identifying the relevant and accent regions within said image; obtaining a plurality of measurements of image composition features in said image, wherein said image composition features comprises at least one of the following: a feature based on the number of relevant and/or accent regions in said image, a feature based on the homogeneity in the layout of the relevant regions, a feature based on the correlation with the position of said relevant regions within the frame; choosing at least one measurement of said plurality of measurements of image composition features for rating said image on a scale regarding said certain subjective characteristic.

### FIELD OF THE INVENTION

The invention relates to the field of image identification, more in particular, it is referred to a new method for classifying images attending to their appearance.

### STATE OF THE ART

Image aesthetics deal with the creation and appreciation of beauty in images. It is composed of many psychological and perceptual factors, including the presence of people in the image and their facial expressions, image sharpness, colorfulness, color harmony and composition. Both web and personal image repositories are increasing exponentially, creating the need for computational algorithms that are able to automatically discern the aesthetically appealing from the unappealing pictures. Algorithms that automatically assess image aesthetics will be at the core of future image management tools and have already been proposed for web and personal image search re-ranking.

Quantifying the aesthetic value of a photograph is a very hard problem, which explains why the simpler problem of classifying images into high vs. low aesthetic appeal has been prevalent in the research community.

Even though it has been found that image composition is the most important attribute when assessing image appeal, current computational approaches to image aesthetics have not analyzed features related to image composition in depth.

Few image aesthetics algorithms have taken image composition features into consideration. Simplicity has been accounted for in various ways: as the number of colors, quantized to 4096 bins, in the background of the region of interest (L₁) [Y. Luo and X. Tang, “Photo and Video Quality Evaluation: Focusing on the Subject,” in Proc. of the 10th European Conf. on Computer Vision: Part III. Springer-Verlag, 2008, p. 399.; the number, up to 5, of segmented regions larger than 1% of the image size (D₁) [R. Datta, D. Joshi, J. Li, and J. Z. Wang, “Studying aesthetics in photographic images using a computational approach,” Lecture Notes in Computer Science, vol. 3953, pp. 288, 2006. or the overall number of segmented regions (F₁) [E. Fedorovskaya, C. Neustaedter, and W. Hao, “Image harmony for consumer images,” in IEEE International Conference on Image Processing, San Diego, Calif., USA, 2008]. Low depth of field photography (i.e., having the region of interest in focus, and the background out of focus has been considered in [Y. Luo and X. Tang, “Photo and Video Quality Evaluation: Focusing on the Subject,” in Proc. of the 10th European Conf. on Computer Vision: Part III. Springer-Verlag, 2008, p. 399.], [P. Obrador, “Region based image appeal metric for consumer photos,” in 2008 IEEE 10th Workshop on Multimedia Signal Processing, 2008, pp. 696-701] and R. Datta, D. Joshi, J. Li, and J. Z. Wang, “Studying aesthetics in photographic images using a computational approach,” Lecture Notes in Computer Science, vol. 3953, pp. 288, 2006.], as well as having the main subject very salient (considered in [L.-K. Wong and K.-L. Low, “Saliency-Enhanced Image Aesthetics Class Prediction,” in 16th IEEE International Conference on Image Processing (ICIP 2009), Cairo, Egypt, 2009.)]) can also help reduce complexity. Visual balance compliance with the rule of thirds is measured in Luo and Tang work by calculating the minimum distance of the centroid of the region of interest to the four power points (L₂). Finally, in Datta, Joshi, Li and Wang contributions as well as in Wong and Low's, the Hue, Saturation and Value (i.e., HSV color space) averages within the inner rule of thirds rectangle are computed.

### SUMMARY OF THE INVENTION

This invention focus on the impact that composition has on aesthetics by taking a close look at image composition theory, and proposing and computing basic features that relate to the so called image composition guidelines or rules. Besides in a detailed experiment a classifier that uses these features to automatically classify images from a baseline image dataset into high vs. low aesthetic appeal.

In a first aspect a method for classifying an image regarding a certain subjective characteristic is disclosed, the method comprising:
identifying relevant and accent regions within said image;
obtaining a plurality of measurements of image composition features in said image, wherein said image composition features comprise at least one of the following:
   a feature based on the number of relevant and/or accent regions in said image,
   a feature based on the homogeneity in the layout of the relevant regions,
   a feature based on the correlation with the position of said relevant regions within the frame;
choosing at least one measurement of said plurality of measurements of image composition features for rating said image on a scale regarding said certain subjective characteristic.

A region is selected as relevant if its relevance is above a threshold, wherein said threshold is a percentage of the relevance of the region and said relevance of a region is calculated as the product of its size and its relative brightness, said relative brightness being obtained from colour's brightness value tables.

Accent regions are selected by inspecting the colour bins from which no relevant regions were selected and being the largest region of such a colour bin selected as an accent region if its size is above a threshold, wherein said threshold is a percentage of the sum of all regions' sizes within said colour bin.

Preferably, the plurality of measurements of image composition features based on the homogeneity on the layout of the relevant regions comprises at least one of the following measurements:
the average distance between centroids of the relevant regions;
the average distance between centroids of the relevant regions, normalized by the image diagonal;
the standard deviation of the average distance between centroids of the relevant regions;
the normalized average distance between the centroids of the relevant regions minus the radii of the relevant regions;
the standard deviation of the normalized average distance between the centroids of the relevant regions minus the radii of the relevant regions;
the standard deviation of the absolute average distance between the centroids of the relevant regions minus the radii of the relevant regions.

The plurality of measurements of image composition features based on the correlation with the position of said relevant regions within the frame comprises at least one measurement F calculated as:

F=Σⱼ₌₁^{M}α(Cₓ_{ⱼ},C_{y}_{ⱼ})

wherein, (Cₓⱼ,C_{yj}) are the coordinates of the centroid of the relevant region j, M is the number of relevant regions in the image and a is obtained from the following expression:

$$α ( x , y ) = K {\sum }_{i = 1}^{D} {e}^{- \frac{{x}^{2} + {y}^{2}}{2 {σ}^{2}}} * {l}^{i} ( x , y )$$

where lⁱ is the i^{th} dividing line for an image composition rule, D is the number of lines of said image composition rule, σ is the standard deviation of a 2D gaussian kernel distribution and K is a normalization factor.

The image composition rules used to measure the features based on the correlation with the position of the relevant regions can optionally be: the rule of thirds, the golden mean rule and the golden triangles rule.

In the case of the golden triangles rule, optionally, the function α is evaluated for all possible rotations of the template's rule.

Besides, in all mentioned rules α is optionally evaluated for a single line of the template's rule or for the total number of lines of the template's rule.

Preferably, σ=Lₘₐₓ/20, where Lₘₐₓ is the length of the image's longer side. Optionally normalization is done by dividing the feature measurement values by the overall number of relevant regions, thus K=1/M. In another aspect of the present invention, a system comprising means adapted to perform the method previously described, is provided.

Finally a computer program comprising computer program code means adapted to perform the method previously described is provided, when said program is run on a computer, a digital signal processor, a field-programmable gate array, an application-specific integrated circuit, a micro-processor, a micro-controller, or any other form of programmable hardware.

### BRIEF DESCRIPTION OF THE DRAWINGS

To complete the description and in order to provide for a better understanding of the invention, a drawing is provided. Said drawing forms an integral part of the description and illustrates a preferred embodiment of architecture for implementing the method of the invention, which should not be interpreted as restricting the scope of the invention, but just as an example of how the invention can be embodied.

FIG. 1 is a table showing the relative brightness of colours used in the method.

FIG. 2 shows three typical image composition rule templates.

FIG. 3 shows 5 image composition rule templates built from the rule of thirds template.

FIG. 4 shows 5 image composition rule templates built from the golden mean rule template.

FIG. 5 shows 12 image composition rule templates built from the golden triangles rule template.

FIG. 6 shows a table with the results of a detailed experiment and their comparison with previous works.

FIG. 7 shows a specific embodiment of the invention.

### DESCRIPTION OF THE INVENTION

This disclosure relates to a method to characterize images through different measurable features regarding image composition and automatically classify them as high/low regarding certain subjective characteristics (i.e., visual appeal, aesthetic, etc).

A plurality of N image composition features measurements (also called basic features measurements) is taken—preferably 55 basic features. In order to classify the image according to a subjective characteristic one or more of these basic features measurements are selected.

Identifying the position of the relevant subjects in the image is of paramount importance. Since the relative brightness of an image object, or region, is so important in order to determine its dominance within the image frame, a colour image segmentation algorithm is used.

Except for the first feature F₁, only relevant regions are taken into consideration by the method.

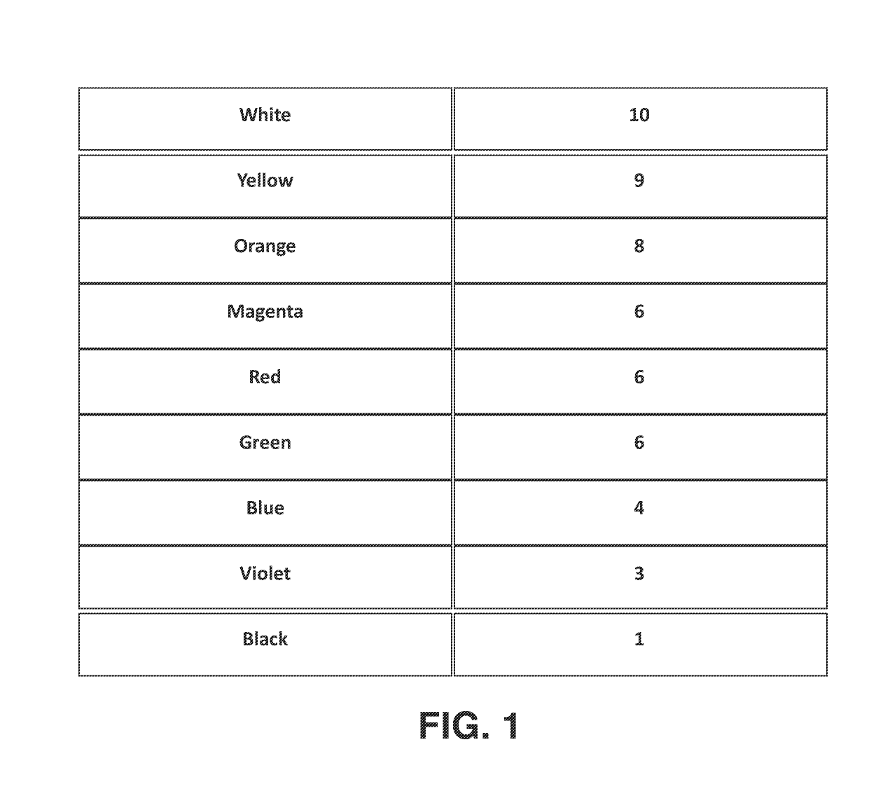

Next the 55 basic features are explained in detail:
the overall number of regions (F₁)
the number of relevant regions (F₂):
   The relevance of a region (Ri) is selected as the product of its size and its relative brightness. In order to account for each region's dominance within the frame, the relative brightness is calculated according to the table shown in FIG. 1 and the remaining weights are interpolated using the colour's brightness value (V, in HSV space, where HSV stands for Hue Saturation and Value).

A region is selected as relevant if its relevance is above a threshold T₁, where T₁ is a percentage of the relevance of the region with maximum relevance.
the number of accent regions (F₃):

Accent regions are selected by inspecting the colour bins from which no regions were selected above (i.e., contrasting colors). The largest region of such a colour bin is selected if its size is above a threshold T₂, where T₂ is a percentage of the sum of all regions' sizes within a colour bin. Colour bins are selected from 25 colours. Thus, a total of 25 pre-specified colour bins is used.

In order to account for a pleasant layout, i.e., the overall visual balance without following a specific rule, a measure of homogeneity in the layout of the relevant regions in the scene is obtained by the following basic features:
the average distance between centroids of the relevant regions, normalized by the image diagonal (F₄),
and without normalization (F₆),
together with their respective standard deviation (F₅ and F₇).
the normalized (F₈) and absolute (F₁₀) average distance between the centroids of the relevant regions minus the radii of the relevant regions, assuming a circular region of area equal to its size (i.e., correlated with distances between regions borders),
and their standard deviation (F₉ and F₁₁).

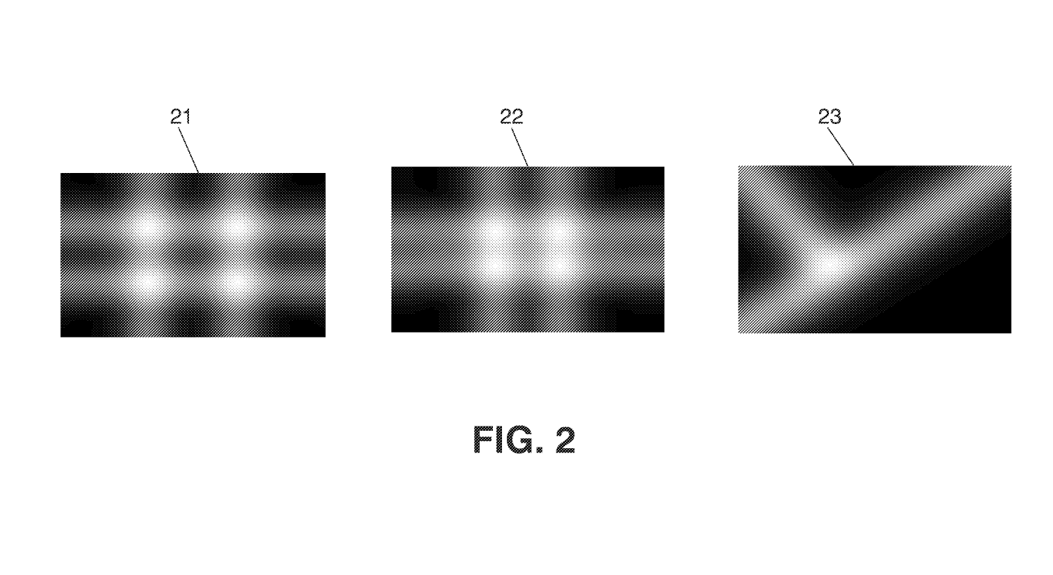

Compositional rules of thumb are usually used in visual arts in order to divide an image into several parts by one or more lines. Proponents of these rules claim that aligning a subject or a region of interest with said dividing lines or their intersections (also called power points) creates more tension, energy or interest that simply centring the subject or region of interest would. Typical compositional rules are Rule of Thirds, Golden Mean (also called Golden Rectangles) and Golden Triangles, whose templates are shown in FIG. 2, respectively 21 22 and 23. In order to generate basic features that will correlate with the position of the relevant regions within the frame, not only the classic rules templates, (i.e.: the rule of thirds, the golden mean and the golden triangles) are used but a complete set of image dependent templates for n rules is devised (i.e., they adapt to different image aspect ratios). Thus a template is created for each specific rule n, by generating each of the rule's dividing lines individually, where lₙⁱ is the i^{th} dividing line for rule n, and convolving them with a 2D gaussian kernel with standard deviation σ. The dividing lines are combined—by adding all of them—creating thus the specific rule's template αₙ:

$${α}_{n} ( x , y ) = K {\sum }_{i = 1}^{D} {e}^{- \frac{{x}^{2} + {y}^{2}}{2 {σ}^{2}}} * {l}_{n}^{i} ( x , y )$$

being D the number of dividing lines in the template, and K a normalization factor. After early experimentation, it was found that σ=Lₘₐₓ/20, where Lₘₐₓ is the length of the image's longer side, generated an appropriate margin around the dividing lines and yielded satisfactory results. In the example of rules' templates 21 22 23 shown in FIG. 2 αₙ corresponds to α₁₂α₃₄21, α₁₇α₃₉22 and α₂₂α₄₄22.

Note that the templates are designed so that if a region's centroid lies close to a power point, it will have a much larger contribution than if it lies close to a dividing line.

The, so called, rule-based visual balance features are, thus, calculated by adding up all the template contributions at each of the relevant regions' centroids; the gaussian introduced above allows for the degradation of the centroid contribution when it deviates from the dividing lines or power points:

Fₙ=Σⱼ₌₁^{M}αₙ(Cₓ_{ⱼ},C_{y}_{ⱼ})

where Fₙ is the feature being considered, Cⱼ are the coordinates of the j^{th} relevant region centroid and M is the number of relevant regions in the image.

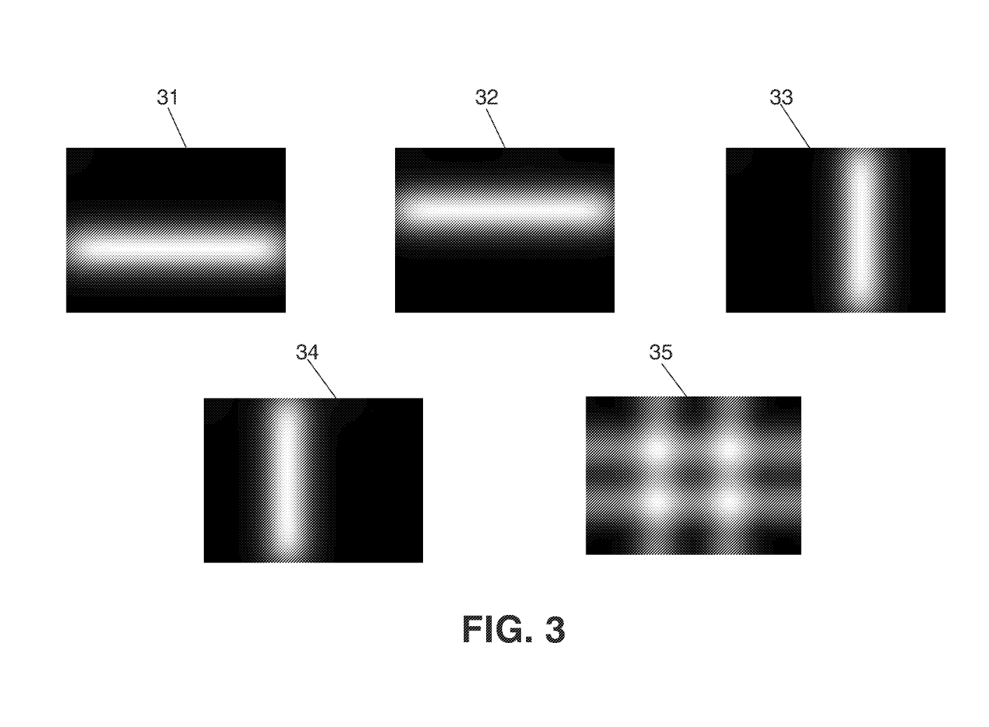

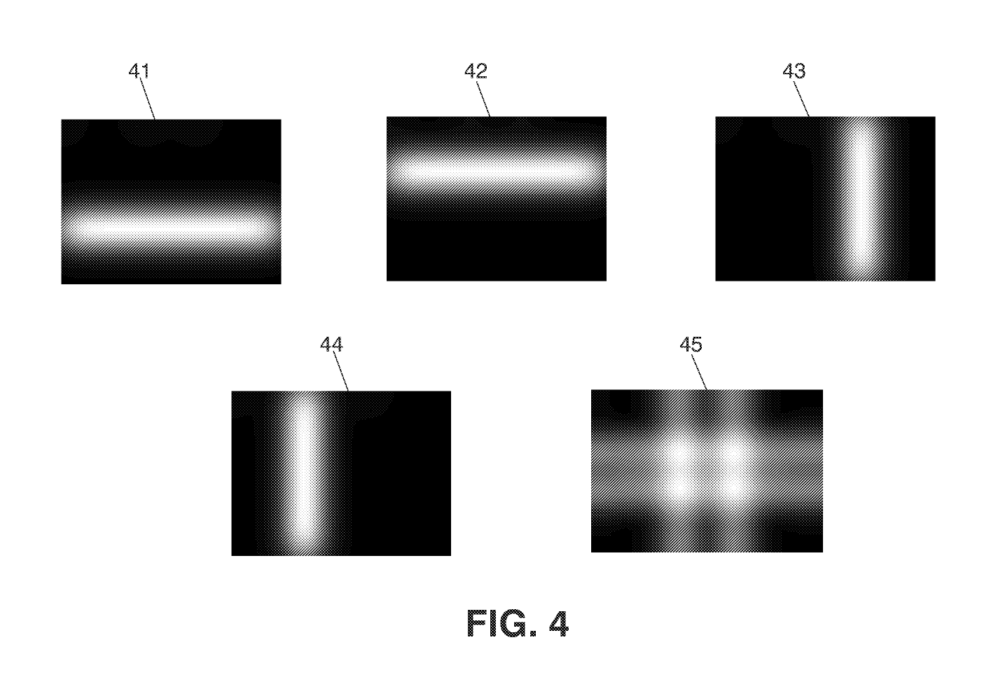

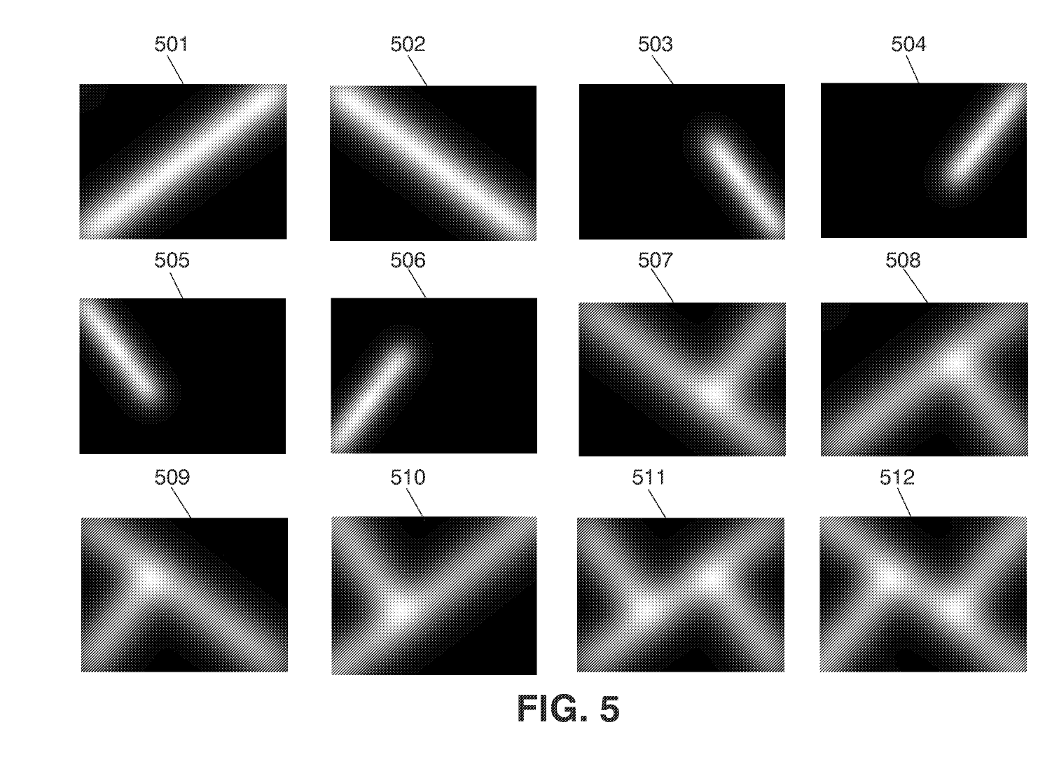

For each of the rules, features are extracted with the entire template, and also with each of the individual dividing lines in the templates. This is done in order to determine if any of them might have a stronger influence than the others, yielding:
5 features for the rule of thirds (F₁₂-F₁₆) extracted from templates 31 32 33 34 35 shown in FIG. 3 and
also 5 features for the golden mean rule (F₁₇-F₂₁) extracted from templates 41 42 43 44 45 shown in FIG. 4.
In the case of the golden triangle's rule, templates are generated for all rotations and symmetries, and also add the combination of the two golden triangle templates given a diagonal dividing line, making up 12 features altogether (F₂₂-F₃₃) extracted from templates 501 502 503 504 505 506 507 508 509 510 511 512 shown in FIG. 5.

Hence, in total, 22 rule-based features are computed plus
their normalized counterparts where normalization is done by dividing the feature values by the overall number of relevant regions (F₃₄-F₅₅).

Finally, in order to classify the image according to a subjective characteristic one or more of these 55 basic features are selected.

Note that from the proposed 55 features, only F₁ has been used in the literature prior to this disclosure.

As can be observed, the invention provides a method of characterizing images which is based only in colour, for assessing simplicity, distance to centroids of region of interest, for assessing visual balance and composition rules similar to the rule of thirds that depend on each image.

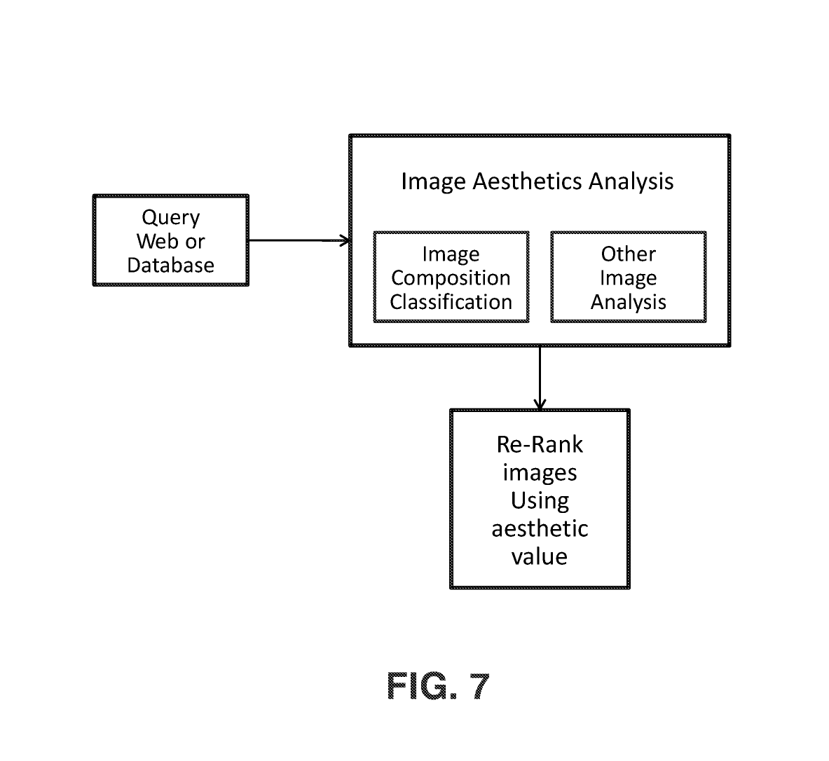

The method of the invention 72 can be optionally used in conjunction with an existing ranking, for example a ranking derived form a search engine in the internet 71. It can help users (specially professional photographers) by ranking, for instance, multiple images taken from the same subject, or ranking images from a database before downloading them into the computer. FIG. 7 shows this case in which 73 indicates the result of the re-ranking.

Next, a particular experiment of the method is detailed, by choosing determined low-level features for classifying the images into high vs. low visual appeal. In order to find the optimal combination of the proposed 55 composition features, an hybrid of filter-based and wrapper-based approach was used. A five-fold cross-validation was carried out with a standard RBF kernel, using the LibSVM package [C. C. Chang and C. J. Lin, LIBSVM: a library for support vector machines, 2001, Software available at http://www.csie.ntu.edu.tw/˜cjlin/libsvm], where the SVM (Support Vector Machine) was run 200 times for each of the low level features and their combinations, for all experiments reported below.

In order to maximize the classification accuracy based on image composition, the experiment was performed with all the possible components of the feature set:
All experiments were run with and without the relative brightness component being considered;
all experiments were run with and without taking the accent component into consideration;
for each of these four component combinations, a full grid search for both thresholds T₁ and T₂ was performed, in 5% steps. The best results were obtained by taking both the relative brightness and the accents into consideration.

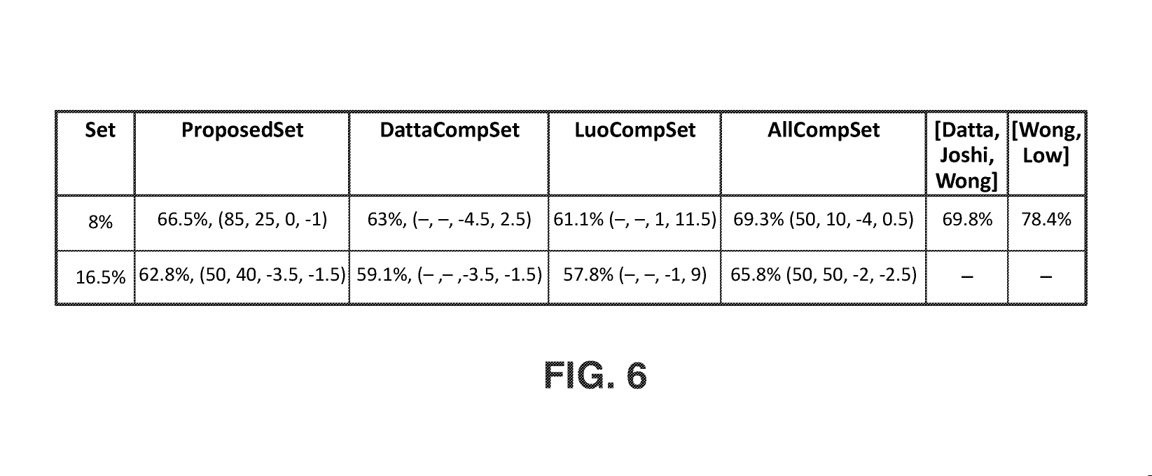

In order to compare with previous work, two competing sets of composition features have been implemented: LuoCompSet, with features L₁ and L₂ [Y. Luo and X. Tang, “Photo and Video Quality Evaluation: Focusing on the Subject,” in Proc. of the 10th European Conf. on Computer Vision: Part III. Springer-Verlag, 2008, p. 399]; and DattaCompSet with D₁-D₄ [R. Datta, D. Joshi, J. Li, and J. Z. Wang, “Studying aesthetics in photographic images using a computational approach,” Lecture Notes in Computer Science, vol. 3953, pp. 288, 2006.]. Finally, the proposed features were combined with L₁-L₂ and D₁-D₄ to generate the results presented under AllCompSet in FIG. 6 which, on the 8% set results in a 5-CV accuracy of 69.3%, where the top 10 features in order of importance are: D₃; F₈; F₁₁; D₄; F₅₁; F₃₉; F₁; F₂₄, F₅₄, and F₆. Where F₂₄'s template is the symmetrical of that of F₂₉. On the same 8% set, the top 6 ProposedSet features (see FIG. 6) in order of importance were: F₄, F₄₄, F₅₁, F₁, F₁₀, F₅₄. When considering individual classification accuracy in the 8% set, with T₁=50, T₂=10, the four top features turned out to be, D₃ (62.1%), F₄ (61.1%), F₈ (60.7%) and F₃₉ (58.4%).

In this text, the term “comprises” and its derivations (such as “comprising”, etc.) should not be understood in an excluding sense, that is, these terms should not be interpreted as excluding the possibility that what is described and defined may include further elements, steps, etc. On the other hand, the invention is obviously not limited to the specific embodiment(s) described herein, but also encompasses any variations that may be considered by any person skilled in the art within the general scope of the invention as defined in the claims.

1. A method for classifying an image regarding a certain subjective characteristic, the method comprising:
identifying relevant and accent regions within said image;
obtaining a plurality of measurements of image composition features in said image, wherein said image composition features comprise at least one of the following:
a feature based on the number of relevant and/or accent regions in said image,
a feature based on the homogeneity in the layout of the relevant regions,
a feature based on the correlation with the position of said relevant regions within the frame;
choosing at least one measurement of said plurality of measurements of image composition features for rating said image on a scale regarding said certain subjective characteristic.

2. The method of claim 1, wherein a region is selected as relevant if its relevance is above a threshold, wherein said threshold is a percentage of the relevance of the region and said relevance of a region is calculated as the product of its size and its relative brightness, said relative brightness being obtained from colour's brightness value tables.

3. The method of claim 2, wherein accent regions are selected by inspecting the colour bins from which no relevant regions were selected and being the largest region of such a colour bin selected as an accent region if its size is above a threshold, wherein said threshold is a percentage of the sum of all regions' sizes within said colour bin.

4. The method of claim 1, wherein said plurality of measurements of image composition features based on the homogeneity on the layout of the relevant regions comprises at least one of the following measurements:
the average distance between centroids of the relevant regions;
the average distance between centroids of the relevant regions, normalized by the image diagonal;
the standard deviation of the average distance between centroids of the relevant regions;
the normalized average distance between the centroids of the relevant regions minus the radii of the relevant regions;
the standard deviation of the normalized average distance between the centroids of the relevant regions minus the radii of the relevant regions;
the standard deviation of the absolute average distance between the centroids of the relevant regions minus the radii of the relevant regions.

5. The method of claim 1, wherein said plurality of measurements of image composition features based on the correlation with the position of said relevant regions within the frame comprises at least one measurement F calculated as:
F=Σⱼ₌₁^{M}α(Cₓ_{ⱼ},C_{y}_{ⱼ})
wherein, (Cₓⱼ,C_{yj}) are the coordinates of the centroid of the relevant region j, M is the number of relevant regions in the image and α is obtained from the following expression:
$$α ( x , y ) = K {\sum }_{i = 1}^{D} {e}^{- \frac{{x}^{2} + {y}^{2}}{2 {σ}^{2}}} * {l}^{i} ( x , y )$$
where lⁱ is the i^{th} dividing line for an image composition rule, D is the number of lines of said image composition rule, σ is the standard deviation of a 2D gaussian kernel distribution and K is a normalization factor.

6. The method of claim 5, wherein said image composition rule is the rule of thirds.

7. The method of claim 5, wherein said image composition rule is the golden mean rule.

8. The method of claim 5, wherein said image composition rule is the golden triangle rule.

9. The method of claim 8, wherein α is evaluated for all possible rotations of the rule's template.

10. The method of claim 5 wherein α is evaluated for a single line of the rule's template.

11. The method of claim 5, wherein σ=Lₘₐₓ/20, where Lₘₐₓ is the length of the image's longer side.

12. The method of claim 5, wherein normalization is done by dividing the feature measurement values by the overall number of relevant regions, thus K=1/M.

13. A system comprising means adapted to perform a method for classifying an image regarding a certain subjective characteristic comprising:
identifying relevant and accent regions within said image;
obtaining a plurality of measurements of image composition features in said image, wherein said image composition features comprise at least one of the following:
a feature based on the number of relevant and/or accent regions in said image,
a feature based on the homogeneity in the layout of the relevant regions,
a feature based on the correlation with the position of said relevant regions within the frame;
choosing at least one measurement of said plurality of measurements of image composition features for rating said image on a scale regarding said certain subjective characteristic.

14. A computer program comprising computer program code means adapted to perform a method for classifying an image regarding a certain subjective characteristic comprising:
identifying relevant and accent regions within said image;
obtaining a plurality of measurements of image composition features in said image, wherein said image composition features comprise at least one of the following:
a feature based on the number of relevant and/or accent regions in said image,
a feature based on the homogeneity in the layout of the relevant regions,
a feature based on the correlation with the position of said relevant regions within the frame;
choosing at least one measurement of said plurality of measurements of image composition features for rating said image on a scale regarding said certain subjective characteristic when said program is run on a computer, a digital signal processor, a field-programmable gate array, an application-specific integrated circuit, a micro-processor, a micro-controller, or any other form of programmable hardware.
